(19) United States
(12) Patent Application Publication
(10) Pub. No.: US 2023/0019361 A1
(43) Pub. Date: Jan. 19, 2023

(54) FLOATING PHOTOVOLTAIC SYSTEM

(71) Applicant: Winterhalder Selbstklebetechnik GmbH, Heitersheim (DE)

(72) Inventor: Marc Van De Ven, Venlo (NL)

(21) Appl. No.: 17/952,491

(22) Filed: Sep. 26, 2022

Related U.S. Application Data
(63) Continuation of application No. PCT/EP2021/057858, filed on Mar. 25, 2021.

(30) Foreign Application Priority Data
Mar. 26, 2020 (DE) 10 2020 108 429.3

(51) Int. Cl. B63B 35/44; H02S 20/00

(52) U.S. Cl. CPC B63B 35/44; H02S 20/00; B63B 2035/4453

(57) ABSTRACT

A floating photovoltaic (PV) system that has a float and at least one PV module. The float is made of two layers, a lower water-permeable layer and an upper water-non-permeable layer. The two layers are held together in a stack configuration, so that when the system is placed in a body of water, the lower layer remains substantially submerged below the surface of the water and the upper layer floats at or above the surface of the water.

### BACKGROUND INFORMATION

### Field of the Invention

The invention relates to the field of photovoltaic systems. More particularly, the invention relates to photovoltaic systems that float on a body of water.

### Discussion of the Prior Art

Photovoltaic (PV) systems are often set up on floating installations in bodies of water, for example, on the oceans or on inland lakes and ponds. Such PV systems require special constructions to withstand the high waves and strong winds that often occur on the seas and on large lakes. It is also important, that the system be sufficiently stable so that it does not capsize or drift under such forces. Rigid floating structures are usually too expensive for commercial use of PV systems, especially at sea.

CN 206481252 U discloses a floating PV system that has ballast weights suspended from a floating platform and that includes a rigid solar module that is mounted indirectly on the platform. The platform is made of an aerated concrete slab and a stabilization vessel, both of which float. This platform has a relatively high dry weight even before it operates as a floating body. In addition, it is necessary to stabilize the structure of the system with ballast weights that are suspended beneath the platform.

What is needed, therefore, is a floating PV system that is lighter in weight and does not require ballast weights to stabilize it.

### BRIEF SUMMARY OF THE INVENTION

The invention is a floating PV system that has a float and at least one photovoltaic module. The float has at least two layers, an upper layer and a lower layer. These two layers are placed one above the other, i.e., stacked together, and are held together to form the float. The lower layer is made of a permeable foam that can take up water and the upper layer made of a foam that is non-permeable to water. A PV module is mounted on the upper surface of the float.

The PV system according to the invention, thus, has a floating base, something like a floating mattress. This floating base is referred to hereinafter simply as ‘float.’ When the PV system is floating in water, the water-absorbing lower layer is at least partially or completely submerged below the surface of the water, while the upper layer, which does not absorb water, provides an upward buoyancy force and floats at or above the surface of the water. The combination of the upper and lower layers provides a float that has a greater moment of inertia, due to the water it has taken up, and, thus, has greater stability and resistance to capsizing and/or drifting.

The upper and lower layers are made of low-density plastic, each having a density lower than the density of water. Because of the different non-permeable and permeable materials used for the upper and lower layers of the float, and because the lower layer is filled with water when in use, the two layers differ in their flexibility and also have different coefficients of expansion and compression. The lower layer is significantly more flexible than the upper layer and is more readily compressible or stretchable. The combination of the upper and lower layers in the floating PV system according to the invention allows the lower layer to deform alternately convexly and concavely in response to the wave action, yet deformation of the upper layer is reliably limited to such a small extent that the forces resulting from the wave action do not damage the PV modules mounted on the floats.

In order for the float to function as intended, the upper and lower layers need to be held together. Adhesives prove to be insufficient for this purpose. In the floating photovoltaic system according to the invention, a film is wrapped around the float in a way that ensures that the upper and lower layers remain in contact with each other and in proper alignment, one above the other, for an extended period of time at sea, possibly for as many as 20 years. The use of film eliminates the need to use an adhesive to hold the layers together. Also films can be welded or fused together, which means that films may be wrapped about the float in various configurations and then securely fastened in place to create the desired enveloping wrap around the float.

The film that is used to wrap around the float is referred to as a ‘wrapping’ film, although this designation of ‘wrapping’ film is not intended to exclude other means of using film to envelope or wrap the stacked layers, so as to hold them together. The wrapping film may be constructed, for example, as a wrapper that is pulled over or wrapped around the stack of layers, or as a three-dimensionally shaped hood that envelopes the layers when it is placed over the stack. Other suitable methods of enveloping the stack of layers may include a hood and a flat covering film, or two comparatively flat hoods with an additional flat film that extends around the layer stack between the two flat hoods and connects the two flat hoods. There are many suitable configurations of wrapping the stack and several configurations are discussed below.

As mentioned above, the two layers must remain in a stack configuration and the lower layer must be able to absorb water. It is possible that the wrapping film be wrapped around the float in such a way that it provides a watertight envelope around the stack. In this case, an opening for the ingress of water has to be provided in the wrapping. It is simpler, however, to provide holes in the wrapping film or to wrap the float in a way that leaves gaps between sections of the film, so that the lower layer is able to take up water when it is placed in the body of water. Either way, in its dry state before it is put into operation at the installation site, the float according to the invention is relatively lightweight and this is a clear advantage when transporting the PV system over land; the float becomes much heavier once the lower layer fills up with water, which is done either before setting the float up at the installation site or when it has been placed in the body of water and automatically takes up water.

One or more film wrappers or a series of film wrappers may be used to wrap around the float. The wave action in oceans and seas exerts forces on the float that cause it to deform or deflect. The use of non-overlapping film wrappers, i.e., sheets of the wrapping film wrapped around sections of the float, with a space between adjacent wrappers, reduces or prevents the formation of folds in the films that may result in rips in one or more of films.

A suitable material for the wrapping film is an ethylene vinyl acetate film (EVA film), but alternatively a polyvinyl chloride film (PVC film) may also be used. Both types of film material are able to be joined by plastic welding techniques, such as thermal welding or chemical welding. It is also possible that a purely mechanical means of joining the film material, such as stitching, may be used to fasten two ends of a wrapped film. At any rate, adhesives or fasteners are not required to fix the films in place on the float.

Rigid PV modules may be mounted directly on the float or mounted on frames, which in turn are mounted on to the float. But it is also possible to mount flexible PV modules directly on the float, for example, placing them directly on the wrapping films that are wrapped around the float.

It may be desirable to connect several floating PV systems to one another, to form a floating island of multiple such systems. To this end, flexible couplings or connectors may be provided on the outer surfaces of the individual floats, for example, be affixed to the wrapping film.

The invention also relates to a method for producing a floating PV system. The method comprises the steps of:
providing a first layer of a first foam material;
providing a second layer of a second foam material;
placing a surface of the second layer against a surface of the first layer to obtain a layer stack;
wrapping a wrapping film around the stack of layers so that the surfaces of the first and second layers remain together,
whereby the first layer is made of a permeable foam material capable of absorbing water,
   and the second layer is made of an non-permeable foam that is impermeable to water.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 is a combined vertical view and perspective view from above, showing six floating PV systems according to the invention, connected to form an island that is anchored to the seabed.

FIG. 2 is a cross-sectional view of the floating PV system according to the invention.

FIG. 3 illustrates how a plurality of film wrappers are used to wrap the float, whereby there is a gap between adjacent film wrappers.

FIG. 4 is a partial perspective view of the float from above, showing a plurality of film wrappers and a long film wrapper that extends in the longitudinal direction and then up onto the upper side of the float.

FIG. 5 is a partial perspective view of the float from below, showing a long film wrapper that extends along the bottom face and then up over an end face of the float.

FIG. 6 is a partial perspective view from above, showing a closing film along the top face.

FIG. 7 is a partial perspective view from above, showing a thin-film PV element mounted on the top face, and connectors for connecting to additional PV systems.

FIG. 8 is a schematic view of a first embodiment of the floating PV system, showing a frame that that holds rigid PV modules and that is mounted on two rows of floats.

FIG. 9 is a partial perspective view from above of a second embodiment of the floating PV system, showing rigid PV modules mounted on the float.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

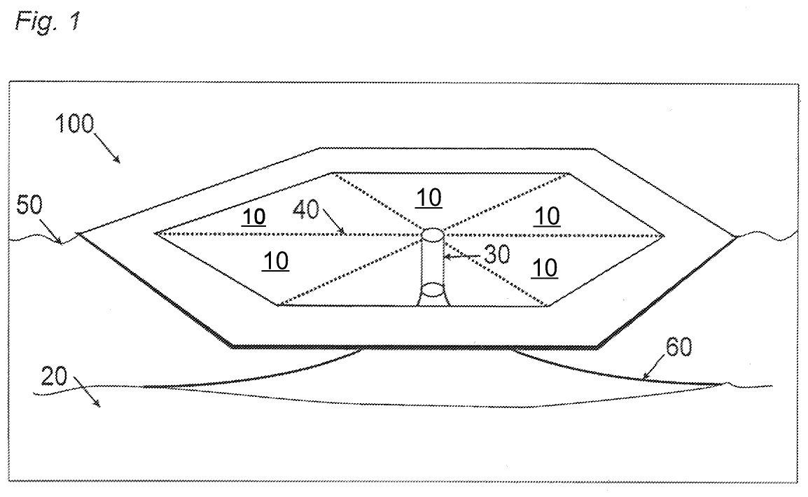

FIG. 1 is an illustration of six floating PV systems 10 according to the invention that are connected to each other to create an island 100 that is floating on the surface 50 of a body of water. The island 100 is anchored to a lakebed or seabed 20 via a central, floating spindle 30 that serves as a mooring. Power cables 40 are also provided on the island 100, which bring the energy generated at the PV systems 10 to some installation located on land. Anchoring means that are known to those skilled in the art, such as anchor lines 60 or buoys, may also be used to anchor the island 100.

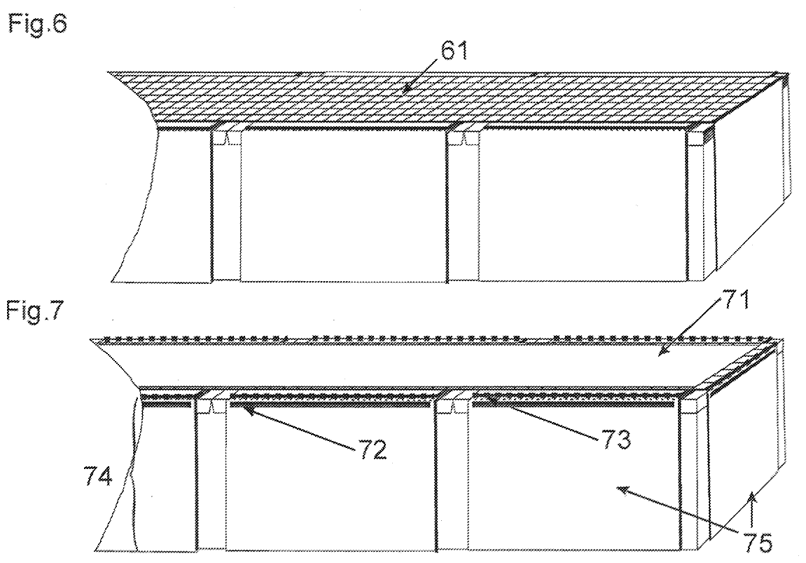

Each of the floating PV systems 10 comprises a float 26 and a PV module 21 that is directly or indirectly mounted on the float 26. When placed in a body of water, a portion of the float 26 is held above the surface of the water 50 and a portion is partially submerged, so that the moment of inertia of the PV systems 10 is below the water surface 50, thereby ensuring stable flow and preventing the systems 10 from drifting. The shape of the float 26 deforms somewhat in response to wave action. The deformable, partially floating structure of the floating PV systems 10 is explained in more detail with reference to FIG. 6.

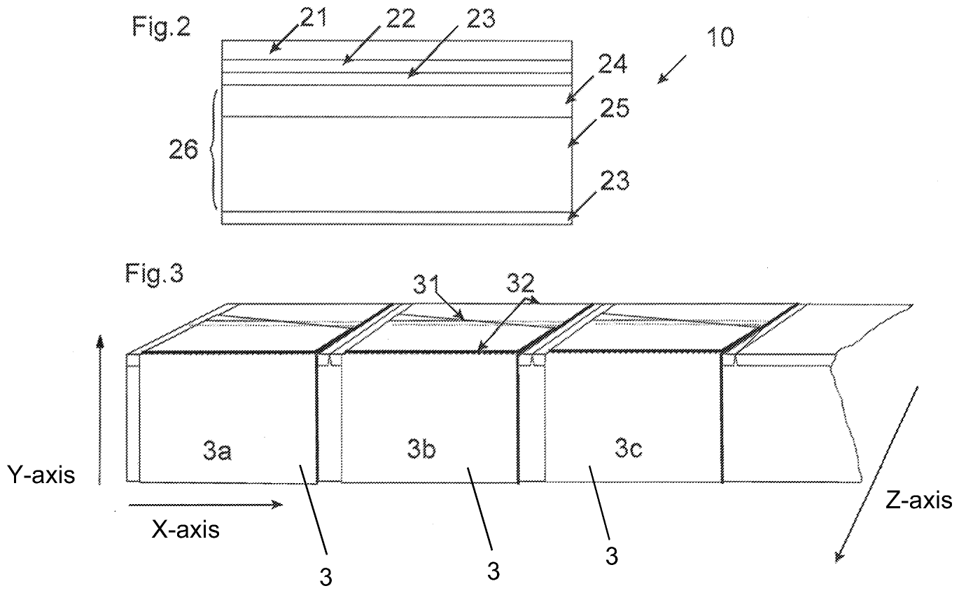

FIG. 2 shows a cross-section of one embodiment of the floating PV system 10 comprising a PV module 21, a carrier film 22, a wrapping film 23, and a float 26 made up of an upper layer 24 and a lower layer 25. In this embodiment, the PV module 21 is a flexible module and is mounted directly on the carrier film 22. The upper and lower layers 24 and 25 have the same length and width and are stacked one on top of the other. A wrapping film 23 is wrapped around the float 26 to hold the two layers 24 and 25 in close contact to each other. The layers 24 and 25 are each configured as a rectangular flat panel having a horizontal width and length larger than the vertical thickness shown in the figures. In the embodiments shown, the width of the upper and lower layers 24 and 25 is approximately 2 m and the length 12 m, the thickness of the upper layer 24 is approximately 10 cm and that of the lower layer 25 is approximately 0.5 m to 1 m.

The upper and lower layers 24 and 25 are made of low-density plastic, each having a density lower than the density of water. The upper layer 24 is made of a non-permeable foam that is impermeable to water and the lower layer 25 made of a permeable foam that is able to absorb water. Thus, the upper layer 24 provides buoyancy to the floating PV system 10, such that the upper layer 24 floats substantially above the water surface 50, whereas the lower layer 25 floats below the surface of the water 50.

Suitable permeable foam materials for the lower layer 25 include open-cell structural foams, such as open-cell foamed polyurethane or latex foam rubber. Alternative embodiments, such as three dimensional woven or nonwoven and water-permeable materials, such as wool or other water absorbent fibers, may also be used to construct the lower layer 25. Suitable foam materials for the upper layer 24 include closed-cell structural foams, such as, for example, closed-cell polyurethane, expanded polystyrene, polyethylene foam, polypropylene foam, or neoprene rubber.

The water-absorbing material of the lower layer 25 preferably has a high porosity with a pore size of about 1 mm and a density of about 30 kg/m³ and a high air permeability of at least 4,500 l/m² and typically about 4,500 l/m². Air permeability in this context refers to the ability of water to penetrate the foam material of the lower layer 25 and displace the air in the pores of the foam material.

The wrapping film 23 is wrapped around at least a portion of the outer surfaces of the stacked layers 24 and 25, to hold the layers in proper alignment, one directly above the other, and thereby ensure the desired floatation and stability. Because a water exchange between the lower layer 25 and the surrounding water may be desirable, the wrapping film 23 preferably is wrapped around approximately 80% of the surface of the stacked layers 24/25, leaving surfaces of particularly the lower layer 25 exposed, for water to flow into and thereby ensure that the moment of inertia of the system 10 is below the surface of the water 50.

When applying the wrapping film 23, care must be taken not to limit the flexibility of the lower layer 25 beyond the minimum flexibility required to maintain a moment of inertia below the water surface 50 when the system 10 is in operation. Suitable methods of wrapping the float 26 are described below with reference to FIGS. 3, 4, and 5. These methods may be implemented in multiple directions to ensure that the lower layer 25 remains flexible in multiple directions.

The carrier film 22 is provided over the wrapping film 23 on the upper face of the upper layer 24 and is fixedly attached to the wrapping film 23, by welding or sewing the films 22, 23 together at sufficient locations to ensure a secure attachment. Alternatively, the carrier film 22 may be integrated into the wrapping film 23 in such a way that the wrapping film 23 provides the functionality of the carrier film 22 and eliminates the need for a separate carrier film. This carrier film provides a rigid, non-compressible, non-stretchable support for the flexible PV module 21.

The flexible PV module 21 is attached to the carrier film 22 with a butyl type attachment. This makes it possible to service and replace the photovoltaic module 21 without lifting the float 26 out of the water. Alternatively, the photovoltaic module 21 may be attached to the carrier film 22 by means of detachable connectors, for example, mechanical connectors such as screws, zippers, hook latches, “Velcro” fasteners, or with an adhesive. Tabs or strips of a weldable material may also be provided, either as separate elements, for example, as “welding strips” that are attached, i.e., welded to the carrier film 22, or as sections of the carrier film 22 that extend beyond the functional carrier portion of the film.

FIG. 3 shows that the wrapping film 23 is provided as a plurality of film wrappers 3. In this illustration, three film wrappers 3a, 3b, 3c are shown, but it is understood that, depending on the length of the floating PV system 10, any suitable number of film wrappers 3 may be used. The edges of adjacent film wrappers 3 do not overlap, instead, sufficiently large gaps are left free between them to allow a certain movability of the foam layers 24 and 25, i.e., to allow particularly the lower layer 25 to deform in response to wave action. In this embodiment, the film wrapper 3 is a sheet of film that is wrapped around the float 26 and the two ends of each sheet brought together on the upper side 32 of the float 26, possibly with some tension applied to the wrapper 3, and are then chemically laminated together, so that each film wrapper 3 forms a closed ring-shaped sleeve around a section of the float 26. In the embodiment shown here, the direction of wrapping extends parallel to the Z axis and the individual film wrappers 3a, 3b, 3c maintain a freedom of movement relative to one another in the direction of the X axis.

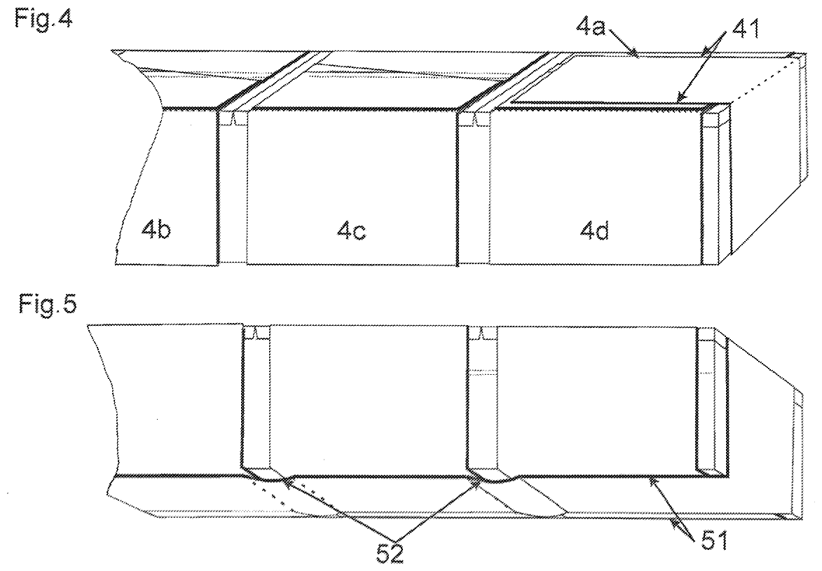

FIGS. 4 and 5 show a supplemental film wrapper 4a of the wrapping film 23 that wraps around the float 26 in a direction parallel to the X axis, and which is hereinafter referred to as a ‘long wrapper.’ The long wrapper 4a extends along the bottom of the float 26 and wraps up over an end face and onto an upper face 41 of the float 26. In FIG. 4, the long wrapper 4a is affixed to a film wrapper 4d that is wrapped around the end section of the float 26. FIG. 5 is a perspective from below and shows the long wrapper 4a extending parallel to the X axis across the bottom face 51 and wrapping up over the end face and onto the top of the float 26. This long wrapper 4a is affixed to a bottom surface of each of the film wrappers 4d, 4c, 4b, but is not affixed to surfaces of the lower layer 25 that are exposed between the wrappers, as shown in FIG. 5 at 52, to allow the necessary freedom of movement that is desired, as will be explained in more detail with reference to FIG. 6.

FIG. 6 shows a closing or end film 61 that extends across the entire upper surface of the float 26, and is affixed to the film wrappers that extend parallel to the X axis in FIGS. 4 and 5 at the two ends of the float 26. Although not shown in FIG. 3, it is also understood that the closing film 61 may be wrapped in a direction parallel to the X axis around the float 26, with the two ends of the film 61 being affixed to a respective wrapper 3 at each end of the float. This closing film 61 provides a stable layer that is not influenced by stretching, compression or shrinkage, i.e., does not allow any deformation in a plane defined by the X and Z axes, but is readily deformable in the direction of the Y axis. The entire top portion of the float 26 is rigid, and the lower portion of the float 26 is flexible and able to stretch and contract. Because of this, the bend line is moved upward from the center of the entire block. This allows PV elements to be mounted on the rigid upper surface of the float 26, without subjecting these elements to forces in a plane formed by the X and Z axis.

FIG. 7 shows a PV module 21 laid across the top of a float 74. In this embodiment, the PV module 21 is a thin-film PV element 71. This is just one of the ways to mount the PV element 21 on the float 74. The thin-film PV element 71 is affixed to a wrapping film 75 that extends across the top surface of at least a portion of the float 74. In the embodiment shown here, connectors 72 and 73 are provided along the upper edges of the float 74. The connectors 72 are hook-and-loop fastening strips. Other types of connectors 73 that are known to those skilled in the art may be used instead of or in addition to the hook-and-loop fastening strips 72. Suitable connectors 73 include hooks and/or latches, cable connectors, etc. These connectors 72 or 73 allow a plurality of PV systems 10 according to the invention to be connected to each other in order to form the floating PV island 100 shown in FIG. 1.

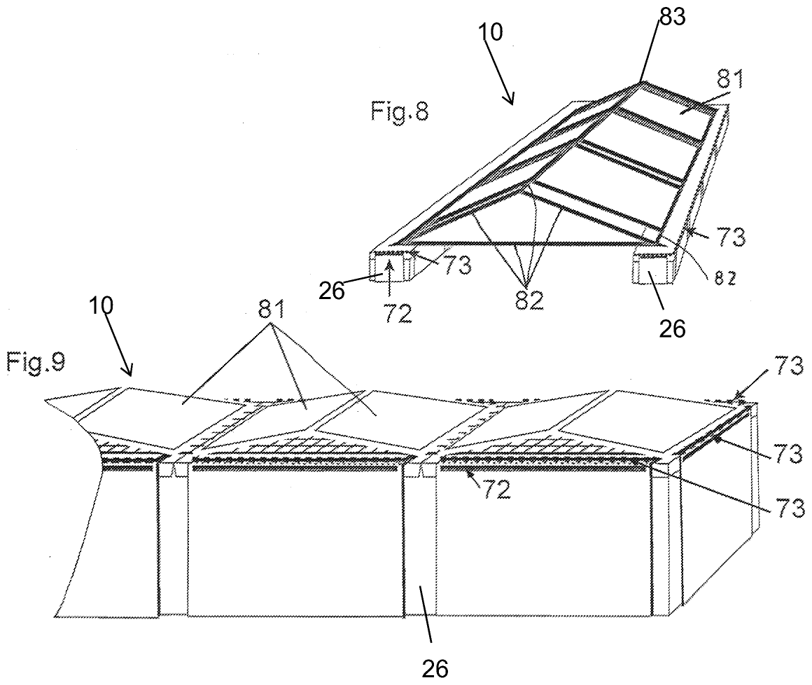

FIG. 8 illustrates an embodiment of the floating PV system 10 that has a rigid PV module 81, instead of the flexible photovoltaic module 71 shown in FIG. 7. Floating PV systems 10 that are intended for use on relatively calm inland waters, such as ponds or lakes, are generally not subjected to the high waves that occur on large bodies of water, such as oceans. Thus, the PV system 10 according to the invention may be equipped with rigid PV elements 81 assembled on a semiconductor substrate. The floats 26 for this embodiment form two long spaced-apart rows. A frame 83 made up of a plurality of struts 82 is mounted on the carrier film 22 on the two rows of floats 26 and rigid PV modules 81 are assembled in the frame 83. The PV modules 81 are arranged in pairs, similar to two roof surfaces sloping down from the peak of a roof, with the ridge line or peak extending parallel to the longitudinal direction of the floats 26. The frame 83 is a torsion-resistant construction and, thus, provides an inherent rigidity of the entire PV system 10 that keeps bending, torsion, or similar deformations to a minimum so as to prevent damage to individual PV modules 81. A flexible coupling means may be used to mount the frame 83 on the floats 26, which allow the floats 26 to deform in response to wave action, without transferring the deformation forces on to the frame 83. The previously described connectors 72 and/or 73 may be provided on the two narrow end faces and on outward-facing sides of the floats 26.

FIG. 9 illustrates a second embodiment of the floating PV system 10 according to the invention that is intended for use in a large body of water, where the foreseeable wave action will generate higher waves than typically occur on inland waters. As with the embodiment in FIG. 8, this PV system 10 also has rigid PV elements 81 that are mounted in a manner similar to a gable roof, but the ridge lines of the pairs of PV elements 81 in this embodiment extend transverse to the longitudinal direction of the float 26, which allows the float 26 to bend upwards or downwards along its length and thus adapt to the wave action. Also, the PV elements 81 are mounted on the float 26, not on a rigid frame, and with a space between adjacent pairs of the PV elements 81. This space acts as a hinge in that two adjacent gabled-roof configurations are able to move relative to each other when the float 26 deforms. This hinge action allows the float 26 to deform in response to the forces exerted by the wave action, but without the individual PV elements 81 themselves having to deform. The two PV elements 81 may also be flexibly connected to one another at the peak of the gable-roof type configuration, so that the roof ridge also acts as a hinge.

In the embodiment shown in FIG. 9, the hook-and-loop strips 72 and/or the connectors 73 may be provided along the outer edges of the float 26, so that a plurality of floats 26 may be connected to form the larger island 100 of the floating PV systems 10 according to the invention.

The invention also relates to a method for manufacturing the floating PV system 10 according to the invention, including the following steps:
providing a first layer of a first foam material;
providing a second layer of a second foam material,
placing a surface of the second layer on a surface of the first layer to obtain a stack of layers,
wrapping a wrapping film around the stack, such that the surfaces of the first and second layers remain up against to each other,
wherein the first layer is made of a permeable foam that can absorb water;
and the second layer is made of a non-permeable foam that is impermeable to water.

The method creates the float 10 that when placed in water the first layer as a lower layer of the stack of layers is at least partially submerged under the water, and the second layer as an upper layer of the stack of layers primarily floats above the surface of the water.

According to one embodiment, the method further comprises the step of using a PV module on a free surface of the upper layer that faces away from the lower layer, whereby the PV module is connected to the layer of film that extends across the free surface.

In a further embodiment, the film layer is a carrier film that is a part of the wrapping film, or is applied to the wrapping film in a process step before placing the PV module on the free surface.

The invention has been described based on several embodiments. Significant modifications and changes will be apparent to those skilled in the art upon reading and understanding the foregoing detailed description. The invention is to be construed as including all such obvious modifications and alterations that fall within the scope of the appended claims.

What is claimed is:

1: A floating photovoltaic (PV) system comprising:
a float having a lower layer that made of a water-permeable foam and an upper layer that is made of a nonpermeable foam that is not water-permeable;
at least one PV module that is supported on the float;
wherein the upper layer is placed on top of the lower layer, so as to form a stacked alignment of the layers; and
wherein, when the float is placed in a body of water, the lower layer is at least partially submerged below the surface of the water and the upper layer is above the surface of the water.

2: The floating PV system of claim 1, wherein the permeable foam is selected from a group of open-cell plastic foam materials including open-cell polyurethane foam and latex foam rubber.

3: The floating PV system of claim 1, wherein the non-permeable foam is selected from a group of plastic foam materials having a closed-cell structure, the group including polyurethane foam with a closed-cell structure, expanded polystyrene, polyethylene foam, polypropylene foam, neoprene rubber.

4: The floating PV system of claim 1, wherein the permeable foam has an air permeability of at least 4000 l/m² and/or a pore size between 0.25 and 2 mm and/or a specific density between 10 and 40 kg/m³.

5: The floating PV system of claim 1, further comprising:
a carrier film that extends between an upper face of the float and the at least one photovoltaic module.

6: The floating PV system of claim 1, wherein the carrier film is made of a plastic selected from a group that includes polyvinyl chloride and ethyl vinyl acetate.

7: The floating PV system of claim 1, further comprising:
a film wrapper that wraps around the float, so as to maintain the stacked alignment of the upper layer and lower layer.

8: The floating PV system of claim 7, wherein the film wrapper is made of a plastic selected from a group that includes polyvinyl chloride and ethyl vinyl acetate.

9: The floating PV system of claim 7, wherein the film wrapper is sealed at least to the ends of the float.

10: The floating PV system of claim 7, wherein the film wrapper includes a long wrapper that extends around the float in a longitudinal direction of the float.

11: The floating PV system of claim 7, wherein the film wrapper includes a plurality of film wrappers, each wrapper wrapping around a section of the float; and wherein there is a gap between adjacent film wrappers that allows the float to bend at the gap.

12: The floating PV system of claim of claim 1, wherein the film wrapper includes a carrier film.

13: The floating PV system of claim 1, wherein the at least one PV module includes a solar panel from a group of solar panels that includes panels with solar cells based on a semiconductor substrate and panels with thin-film PV elements.

14: The floating PV system of claim 5, wherein the solar panel is attached to a carrier film be means of a flexible coupling.

15: The floating PV system of claim 1, further comprising:
one or more flexible couplings that are mounted on outer edges of the float.

16: The floating PV system of claim 7, further comprising:
one or more flexible couplings that are affixed to the film wrapper.

17: The floating PV system of claim 1, further comprising:
a frame made of a plurality of struts and that is mounted on the float;
wherein PV elements are mounted in the frame.

18: The floating PV system of claim 17, wherein rigid PV elements are mounted in the frame.
